(19) United States
(12) Patent Application Publication
(10) Pub. No.: US 2026/0361858 A1
(43) Pub. Date: Nov. 12, 2026

(54) Method and Apparatus of Region-based Intra Prediction Using Template-based or Decoder Side Intra Mode Derivation in Video Coding System

(71) Applicant: MEDIATEK INC., Hsinchu City (TW)

(72) Inventors: Man-Shu CHIANG, Hsinchu City (TW); Chih-Wei HSU, Hsinchu City (TW)

(21) Appl. No.: 19/120,864

(22) PCT Filed: Oct. 20, 2023
(86) PCT No.: PCT/CN2023/125789

§ 371 Date: Apr. 14, 2025

Related U.S. Application Data
(60) Provisional application No. 63/380,394, filed on Oct. 21, 2022.

(51) Int. Cl. H04N 19/11; H04N 19/105; H04N 19/176

(52) U.S. Cl. CPC H04N 19/11; H04N 19/105; H04N 19/176

(57) ABSTRACT

A method and apparatus for video coding are disclosed. According to this method, input data associated with a current block are received, wherein the input data comprise pixel data to be encoded at an encoder side or coded data associated with the current block to be decoded at a decoder side. A first template region and a second template region are determined for the current block. One or more first target prediction modes are determined based on the first template region. One or more second target prediction modes are determined based on the second template region. A final predictor for is generated the current block based on coding information comprising said first target prediction modes and/or said second target prediction modes. The current block is encoded or decoded using the final predictor.

### CROSS REFERENCE TO RELATED APPLICATIONS

The present invention is a non-Provisional Application of and claims priority to U.S. Provisional Patent Application No. 63/380,394, filed on Oct. 21, 2022. The U.S. Provisional Patent Application is hereby incorporated by reference in its entirety.

### FIELD OF THE INVENTION

The present invention relates to video coding system. In particular, the present invention relates to schemes to improve performance of intra prediction modes using one or more region-based templates to evaluate the costs associated with candidate modes and to select a target intra prediction mode for each region-based template in a video coding system.

### BACKGROUND AND RELATED ART

Versatile video coding (VVC) is the latest international video coding standard developed by the Joint Video Experts Team (JVET) of the ITU-T Video Coding Experts Group(VCEG) and the ISO/IEC Moving Picture Experts Group(MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously encoded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In the present invention, methods to improve the prediction accuracy by blending the prediction from multiple intra prediction modes derived using multiple region-based templates are disclosed.

### BRIEF SUMMARY OF THE INVENTION

A method and apparatus for video coding are disclosed. According to this method, input data associated with a current block are received, wherein the input data comprise pixel data to be encoded at an encoder side or data associated with the current block to be decoded at a decoder side. A first template region and a second template region are determined for the current block. One or more first target prediction modes are determined based on the first template region. One or more second target prediction modes are determined based on the second template region. A final predictor for is generated the current block based on coding information comprising said first target prediction modes and/or said second target prediction modes. The current block is encoded or decoded using the final predictor.

In one embodiment, the first template region corresponds to a top template on a top side of the current block and the second template region corresponds to a left template on a left side of the current block.

In one embodiment, a first prediction candidate list is determined for the first template region. First costs associated with first prediction candidates in the first prediction candidate list are calculated, and said one or more first target prediction modes are selected according to the first costs. The first costs associated with the first prediction candidates in the first prediction candidate list may be calculated based on histogram/gradient analysis on the first template region, distortion calculation on the first template region, and/or any-pre-defined measurement on the first template region). In one embodiment, said one or more first target prediction modes are included in the second prediction candidate list for the second template region. In one embodiment, second costs associated with second prediction candidates in the second prediction candidate list are calculated, and said one or more second target prediction modes are selected according to the second costs. The second costs associated with the second prediction candidates in the second prediction candidate list can be calculated based on histogram/gradient analysis on the second template region, distortion calculation on the second template region, and/or any-pre-defined measurement on the second template region.

In one embodiment, one first target prediction mode and one second target prediction mode are selected, and the final predictor is generated by blending a first predictor corresponding to said selected one first target prediction mode and a second predictor corresponding to said selected one second target prediction mode, and wherein said selected one first target prediction mode has a smallest first cost among said one or more first target prediction modes and said selected one second target prediction mode has a smallest second cost among said one or more first target prediction modes.

In one embodiment, the first predictor and the second predictor are blended on a per-sample basis. In one embodiment, the first predictor and the second predictor are blended using a weighting scheme. For example, the weighting scheme corresponds to a pre-defined weighting scheme. In another example, one or more weights for the weighting scheme depend on sample position within the current block, block width or height of the current block, first costs associated with first prediction candidates in a first prediction candidate list for the first template region, second costs associated with second prediction candidates in a second prediction candidate list for the second template region, first distance between the sample position and the first template region, second distance between the sample position and the second template region, or any combination thereof.

In one embodiment, the first template region is divided into one or more first template sub-regions and/or the second template region is divided into one or more second template sub-regions, and wherein one or more first target sub-region prediction modes are derived for each of said one or more first template sub-regions and one or more second target sub-region prediction modes are derived for each of said one or more second template sub-regions. Said each of said one or more first template sub-regions is derived based on first sub-region costs associated with said each said one or more first template sub-regions and/or said each of said one or more second template sub-regions is derived based on second sub-region costs associated with said each said one or more second template sub-regions.

In one embodiment, the final predictor for the current block is generated based on the coding information comprising said one or more first target sub-region prediction modes and said one or more second target sub-region prediction modes. In one embodiment, in response to only the first template region being divided into one or more first template sub-regions, the final predictor for the current block is generated based on the coding information comprising said one or more first target sub-region prediction modes and said one or more second target prediction modes. In another embodiment, in response to only the second template region being divided into one or more second template sub-regions, the final predictor for the current block is generated based on the coding information comprising said one or more first target prediction modes and said one or more second target sub-region prediction modes. In yet another embodiment, the current block is divided into subblocks, and final subblock predictors for the subblocks are generated based on the coding information comprising said one or more first target sub-region prediction modes and said one or more second target sub-region prediction modes respectively. In yet another embodiment, the current block is divided into subblocks according to block width, block height, block area, dividing on the first template region, dividing on the second template region, or a combination thereof.

In one embodiment, each of the first sub-region costs or each of the second sub-region costs is calculated for each first sub-region or each second sub-region respectively using reference samples corresponding to all or any subset of outer reference L shape around the first template region on a top side of the current block and around the second template region on a left side of the current block. In another embodiment, each of the first sub-region costs or each of the second sub-region costs is calculated for each first sub-region or each second sub-region respectively using reference samples adjacent to said each first sub-region or said each second sub-region respectively.

In one embodiment, an overlapping area is determined around a boundary between two adjacent subblocks of the current block, and the overlapping area is further blended according to two prediction modes associated with the two adjacent subblocks of the current block.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 illustrates an example of the signalling mechanism of the partition splitting information in quadtree with nested multi-type tree coding tree structure.

FIG. 4 shows an example of a CTU divided into multiple CUs with a quadtree and nested multi-type tree coding block structure, where the bold block edges represent quadtree partitioning and the remaining edges represent multi-type tree partitioning.

FIG. 5 shows some examples of TT split forbidden when either width or height of a luma coding block is larger than 64.

FIG. 6 shows the intra prediction modes as adopted by the VVC video coding standard.

FIG. 7 illustrates the locations of the neighbouring blocks (L, A, BL, AR, AL) used in the derivation of a general MPM list.

FIGS. 8A-B illustrate examples of wide-angle intra prediction a block with width larger than height (FIG. 8A) and a block with height larger than width (FIG. 8B).

FIG. 9A illustrates an example of selected template for a current block, where the template comprises T lines above the current block and T columns to the left of the current block.

FIG. 9B illustrates an example for T=3 and the HoGs (Histogram of Gradient) are calculated for pixels in the middle line and pixels in the middle column.

FIG. 9C illustrates an example of the amplitudes (ampl) for the angular intra prediction modes.

FIG. 10 illustrates an example of the blending process, where two angular intra modes (M1 and M2) are selected according to the indices with two tallest bars of histogram bars.

FIG. 11 illustrates an example of template-based intra mode derivation (TIMD) mode, where TIMD implicitly derives the intra prediction mode of a CU using a neighbouring template at both the encoder and decoder.

FIG. 12A illustrates an example of Intra Sub-Partition (ISP), where a block is partitioned into two subblocks horizontally or vertically.

FIG. 12B illustrates an example of Intra Sub-Partition (ISP), where a block is partitioned into four subblocks horizontally or vertically.

FIG. 13 illustrates an example of the of 64 partitions used in the VVC standard, where the partitions are grouped according to their angles and dashed lines indicate redundant partitions.

FIG. 14 illustrates an example of uni-prediction MV selection for the geometric partitioning mode.

FIG. 15 illustrates an example of bending weight ω₀ using the geometric partitioning mode.

FIG. 16 illustrates an example of the weight value derivation for Combined Inter and Intra Prediction (CIIP) according to the coding modes of the top and left neighbouring blocks.

FIG. 17 illustrates an example of neighbouring L-shape reference samples including a top region on the top side of the current block, a left region on a left side of the current block and a top-left region of the current block.

FIG. 18 illustrates an example of neighbouring L-shape reference samples by extending the top region and the left region of the neighbouring L-shape reference samples in FIG. 17.

FIG. 19 illustrates an example of neighbouring L-shape reference samples by excluding the top-left region of the neighbouring L-shape reference samples in FIG. 17.

FIG. 20A illustrates an example of neighbouring L-shape reference samples by only including the top region of the neighbouring L-shape reference samples.

FIG. 20B illustrates an example of neighbouring L-shape reference samples by only including the left region of the neighbouring L-shape reference samples.

FIG. 21 illustrates an example of dividing the top reference region into sub-regions and dividing the left reference region into sub-regions.

FIG. 22 illustrates an example of generating predictors for a sub-region, where the reference samples to generate the predictors are the adjacent L shape of the sub-region.

FIG. 23 illustrates an example of generating predictors for a sub-region, where the reference samples to generate the predictors are the outer L shape of the top and left regions of the current block.

FIG. 24 shows an example of deriving a total of 8 representative intra prediction modes (denoted as m0, m1, m2, m3, n0, n1, n2, and n3) from the neighbouring suggestion and generating 8 hypotheses of predictions for the current block.

FIG. 25 shows an example for this embodiment, where a total of 2 representative intra prediction modes (denoted as m0 and n0) are derived from the neighbouring suggestion and 2 hypotheses of predictions for the current block are generated.

FIG. 26 illustrates an example of dividing a 16×16 block into 16 subblocks (denoted as sbij where i=0, 1, 2, or 3 and j=0, 1, 2, or 3), where corresponding reference sub-regions including one from the top region and one from the left region are used to derive representative sub-region intra prediction modes.

FIG. 27 shows the overlapped regions (as indicated by dotted areas) for all subblocks, where the overlapping region uses further blended predictions generated according to the intra prediction modes of neighbouring blocks

FIG. 28 illustrates a flowchart of an exemplary video coding system that incorporates blending multiple representative intra modes derived from multiple template region according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Partitioning of the CTUs Using a Tree Structure

In HEVC, a CTU is split into CUs by using a quaternary-tree (QT) structure denoted as coding tree to adapt to various local characteristics. The decision whether to code a picture area using inter-picture (temporal) or intra-picture (spatial) prediction is made at the leaf CU level. Each leaf CU can be further split into one, two or four Pus according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

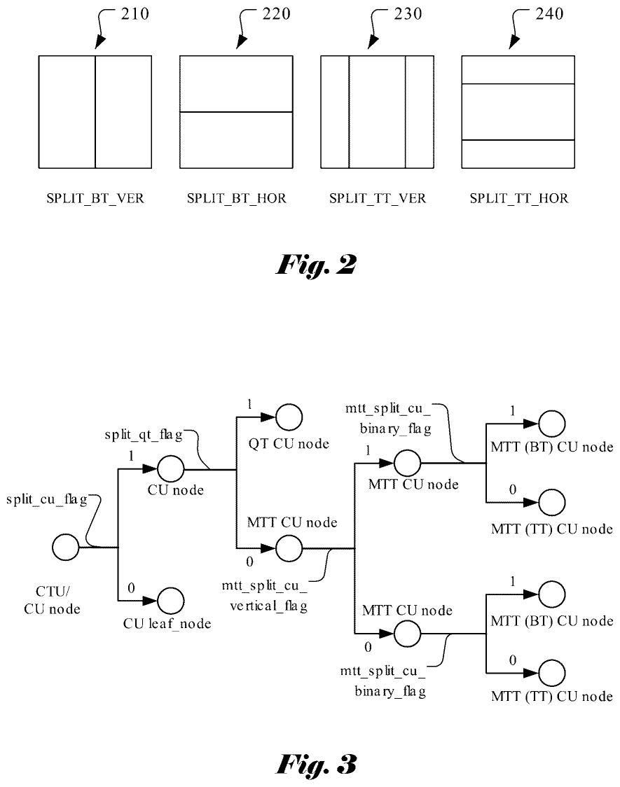

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 3 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In quadtree with nested multi-type tree coding tree structure, for each CU node, a first flag (split_cu_flag) is signalled to indicate whether the node is further partitioned. If the current CU node is a quadtree CU node, a second flag (split_qt_flag) whether it's a QT partitioning or MTT partitioning mode. When a node is partitioned with MTT partitioning mode, a third flag (mtt_split_cu_vertical_flag) is signalled to indicate the splitting direction, and then a fourth flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1.

TABLE 1
MttSplitMode derivation based on multi-type tree syntax elements

| | mtt_split_cu_ver- | mtt_split_cu_bi- |
|---|---|---|
| MttSplitMode | tical_flag | nary_flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

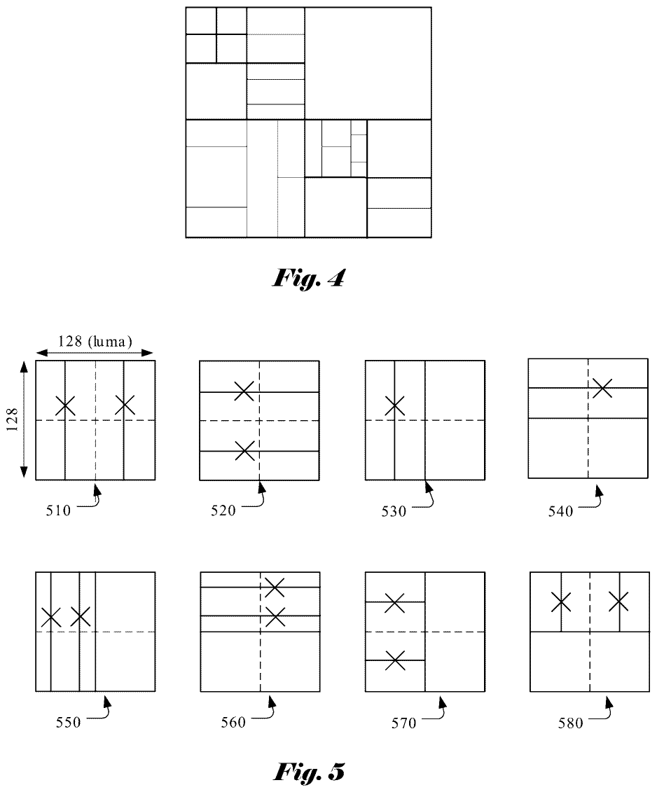

FIG. 4 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined for the quadtree with nested multi-type tree coding tree scheme. These parameters are specified by SPS syntax elements and can be further refined by picture header syntax elements.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinCbSize: the minimum allowed coding block node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinCbsize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 128×128). Otherwise, the leaf qdtree node could be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinCbsize, no further horizontal splitting is considered. Similarly, when the multi-type tree node has height equal to MinCbsize, no further vertical splitting is considered.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

### Virtual Pipeline Data Units (VPDUs)

Virtual pipeline data units (VPDUs) are defined as non-overlapping units in a picture. In hardware decoders, successive VPDUs are processed by multiple pipeline stages at the same time. The VPDU size is roughly proportional to the buffer size in most pipeline stages, so it is important to keep the VPDU size small. In most hardware decoders, the VPDU size can be set to maximum transform block (TB) size. However, in VVC, ternary tree (TT) and binary tree (BT) partition may lead to the increasing of VPDUs size.

In order to keep the VPDU size as 64×64 luma samples, the following normative partition restrictions (with syntax signalling modification) are applied in VTM, as shown in FIG. 5:
TT split is not allowed (as indicated by “X” in FIG. 5) for a CU with either width or height, or both width and height equal to 128.
For a 128×N CU with N≤64 (i.e. width equal to 128 and height smaller than 128), horizontal BT is not allowed.
For an N×128 CU with N≤64 (i.e. height equal to 128 and width smaller than 128), vertical BT is not allowed.

In FIG. 5, the luma block size is 128×128. The dashed lines indicate block size 64×64. According to the constraints mentioned above, examples of the partitions not allowed are indicated by “X” as shown in various examples (510-580) in FIG. 5.

Intra Mode Coding with 67 Intra Prediction Modes

To capture the arbitrary edge directions presented in natural video, the number of directional intra modes in VVC is extended from 33, as used in HEVC, to 65. The new directional modes not in HEVC are depicted as dotted arrows in FIG. 6, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

To keep the complexity of the most probable mode (MPM) list generation low, an intra mode coding method with 6 MPMs is used by considering two available neighbouring intra modes. The following three aspects are considered to construct the MPM list:
Default intra modes
Neighbouring intra modes
Derived intra modes.

A unified 6-MPM list is used for intra blocks irrespective of whether MRL and ISP coding tools are applied or not. The MPM list is constructed based on intra modes of the left and above neighbouring block. Suppose the mode of the left is denoted as Left and the mode of the above block is denoted as Above, the unified MPM list is constructed as follows:
When a neighbouring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, M+2}
If Left and Above are both angular and they are different:
   Set a mode Max as the larger mode in Left and Above
   If Max-Min is equal to 1:
      MPM list→{Planar, Left, Above, Min−1, Max+1, Min−2}
   Otherwise, if Max-Min is greater than or equal to 62:
      MPM list→{Planar, Left, Above, Min+1, Max−1, Min+2}
   Otherwise, if Max-Min is equal to 2:
      MPM list→{Planar, Left, Above, Min+1, Min−1, Max+1}
   Otherwise:
      MPM list→{Planar, Left, Above, Min−1,−Min+1, Max−1}
If Left and Above are both angular and they are the same:
   MPM list→{Planar, Left, Left−1, Left+1, Left−2, Left+2}

Besides, the first bin of the MPM index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

Secondary MPM lists is introduced as described in JVET-D0114 (Seregin, et al., “Block shape dependent intra mode coding”, Joint Video Exploration Team (JVET) of ITU-T SG 16 WP 3 and ISO/IEC JTC 1/SC 29/WG 11, 4th Meeting: Chengdu, CN, 15-21 Oct. 2016, Document JVET-D0114). The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in the following, the directional modes with added offset from the first two available directional modes of neighbouring blocks, and the default modes.

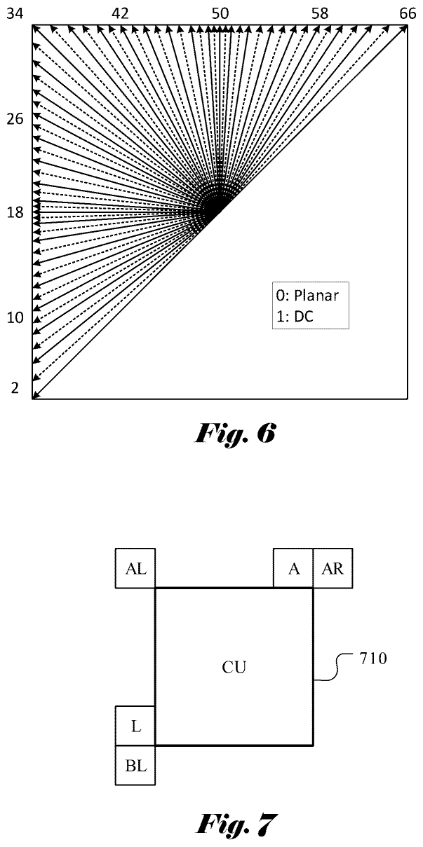

If a CU block is vertically oriented, the order of neighbouring blocks is A, L, BL, AR, AL; otherwise, it is L, A, BL, AR, AL. FIG. 7 illustrates the locations of the neighbouring blocks (L, A, BL, AR, AL) used in the derivation of a general MPM list for a current block 710.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

To support these prediction directions, the top reference with length 2W+1, and the left reference with length 2H+1, are defined as shown in FIG. 8A and FIG. 8B respectively.

The number of replaced modes in wide-angular direction mode depends on the aspect ratio of a block. The replaced intra prediction modes are illustrated in Table 2.

TABLE 2
Intra prediction modes replaced by wide-angular modes

| Aspect ratio | Replaced intra prediction modes |
|---|---|
| W / H == 16 | Modes 12, 13, 14, 15 |
| W / H == 8 | Modes 12, 13 |
| W / H == 4 | Modes 2, 3, 4, 5, 6, 7, 8, 9, 10, 11 |
| W / H == 2 | Modes 2, 3, 4, 5, 6, 7, |
| W / H == 1 | None |
| W / H == ½ | Modes 61, 62, 63, 64, 65, 66 |
| W / H == ¼ | Mode 57, 58, 59, 60, 61, 62, 63, 64, 65, 66 |
| W / H == ⅛ | Modes 55, 56 |
| W / H == 1/16 | Modes 53, 54, 55, 56 |

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135° and above 45°, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### Decoder Side Intra Mode Derivation (DIMD)

When DIMD is applied, two intra modes are derived from the reconstructed neighbour samples, and those two predictors are combined with the planar mode predictor with the weights derived from the gradients. The DIMD mode is used as an alternative prediction mode and is always checked in the high-complexity RDO mode.

To implicitly derive the intra prediction modes of a blocks, a texture gradient analysis is performed at both the encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left side and above side of the current block. This area is used as the reference for the gradient based intra prediction modes derivation.

In the second step, the horizontal and vertical Sobel filters are applied on all 3×3 window positions, centred on the pixels of the middle line of the template. At each window position, Sobel filters calculate the intensity of pure horizontal and vertical directions as Gₓ and G_{y}, respectively. Then, the texture angle of the window is calculated as:

angle=arctan(Gₓ/G_{y}), (1)
which can be converted into one of 65 angular intra prediction modes. Once the intra prediction mode index of current window is derived as idx, the amplitude of its entry in the HoG[idx] is updated by addition of:

ampl=|Gₓ|+|G_{y}| (2)

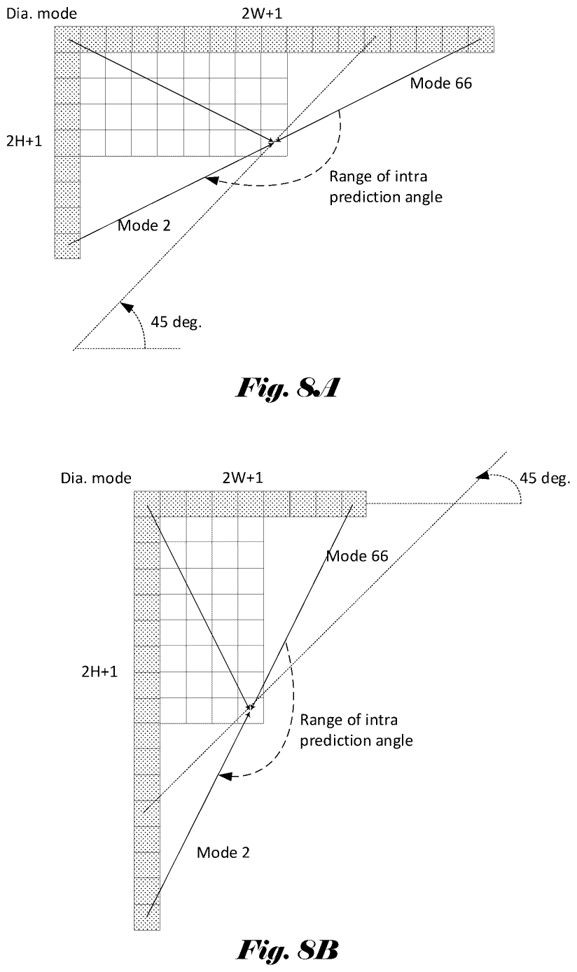

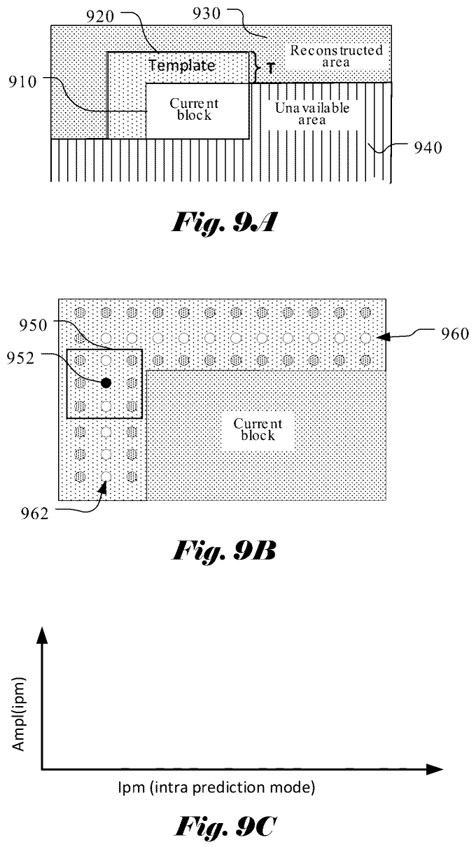

FIGS. 20A-C show an example of HoG, calculated after applying the above operations on all pixel positions in the template. FIG. 9A illustrates an example of selected template 920 for a current block 910. Template 920 comprises T lines above the current block and T columns to the left of the current block. For intra prediction of the current block, the area 930 at the above and left of the current block corresponds to a reconstructed area and the area 940 below and at the right of the block corresponds to an unavailable area. FIG. 9B illustrates an example for T=3 and the HoGs are calculated for pixels 960 in the middle line and pixels 962 in the middle column. For example, for pixel 952, a 3×3 window 950 is used. FIG. 9C illustrates an example of the amplitudes (ampl) calculated based on equation (2) for the angular intra prediction modes as determined from equation (1).

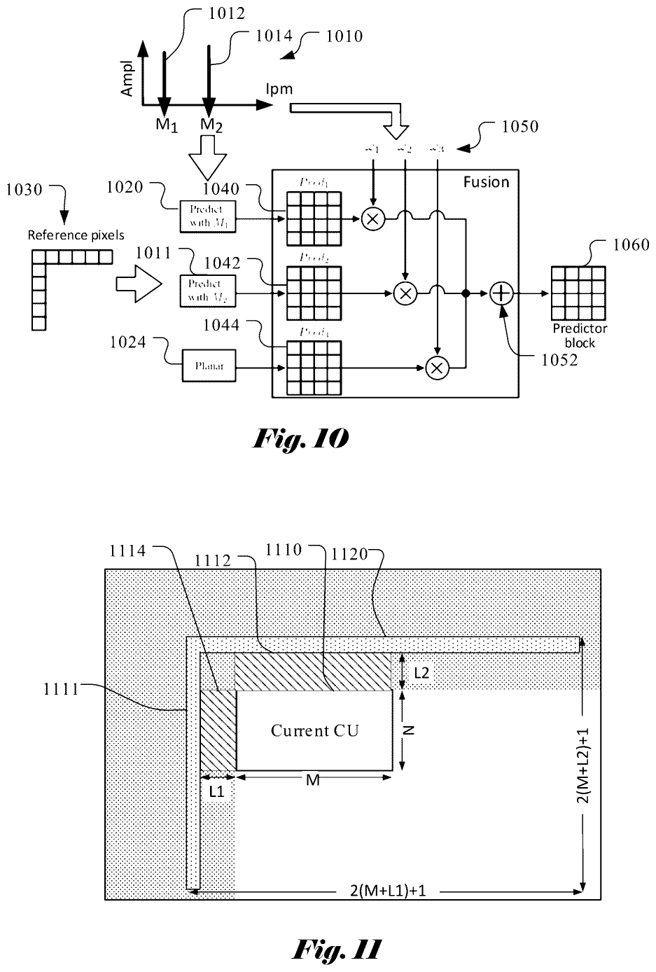

Once HoG is computed, the indices with two tallest histogram bars are selected as the two implicitly derived intra prediction modes for the block and are further combined with the Planar mode as the prediction of DIMD mode. The prediction fusion is applied as a weighted average of the above three predictors. To this aim, the weight of planar is fixed to 21/64 (~⅓). The remaining weight of 43/64 (~⅔) is then shared between the two HoG IPMs, proportionally to the amplitude of their HoG bars. FIG. 10 illustrates an example of the blending process. As shown in FIG. 10, two intra modes (M1 1012 and M2 1014) are selected according to the indices with two tallest bars of histogram bars 1010. The three predictors (1040, 1042 and 1044) are used to form the blended prediction. The three predictors correspond to applying the M1, M2 and planar intra modes (1020, 1022 and 1024 respectively) to the reference pixels 1030 to form the respective predictors. The three predictors are weighted by respective weighting factors (ω1, ω2 and ω3) 1050. The weighted predictors are summed using adder 1052 to generated the blended predictor 1060.

Besides, the two implicitly derived intra modes are included into the MPM list so that the DIMD process is performed before the MPM list is constructed. The primary derived intra mode of a DIMD block is stored with a block and is used for MPM list construction of the neighbouring blocks.

### Template-based Intra Mode Derivation (TIMD)

Template-based intra mode derivation (TIMD) mode implicitly derives the intra prediction mode of a CU using a neighbouring template at both the encoder and decoder, instead of signalling the intra prediction mode to the decoder. As shown in FIG. 11, the prediction samples of the template (1112 and 1114) for the current block 1110 are generated using the reference samples (1120 and 1111) of the template for each candidate mode. A cost is calculated as the SATD (Sum of Absolute Transformed Differences) between the prediction samples and the reconstruction samples of the template. The intra prediction mode with the minimum cost is selected as the DIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

costMode2<2*costMode1.

If this condition is true, the fusion is applied, otherwise only model is used. Weights of the modes are computed from their SATD costs as follows:

weight1=costMode2/(costMode1+costMode2)

weight2=1−weight1.

### Intra Sub-Partitions (ISP)

The intra sub-partitions (ISP) divides luma intra-predicted blocks vertically or horizontally into 2 or 4 sub-partitions depending on the block size. For example, the minimum block size for ISP is 4×8 (or 8×4). If block size is greater than 4×8 (or 8×4), then the corresponding block is divided by 4 sub-partitions. It has been noted that the M×128 (with M≤64) and 128×N (with N≤64) ISP blocks could generate a potential issue with the 64×64 VDPU (Virtual Decoder Pipeline Unit). For example, an M×128 CU in the single tree case has an M×128 luma TB and two corresponding

$$\frac{M}{2} \times 64$$

chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU size that can use ISP is restricted to a maximum of 64×64. FIG. 12A and FIG. 12B shows examples of the two possibilities. All sub-partitions fulfil the condition of having at least 16 samples.

In ISP, the dependence of 1×N and 2×N subblock prediction on the reconstructed values of previously decoded 1×N and 2×N subblocks of the coding block is not allowed so that the minimum width of prediction for subblocks becomes four samples. For example, an 8×N (N>4) coding block that is coded using ISP with vertical split is partitioned into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks compared to processing 4×4 regular-coded intra blocks.

TABLE 3

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed consecutively. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 3. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
Transform size restriction: all ISP transforms with a length larger than 16 points uses the DCT-II.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let t_{H} and t_{V} be the horizontal and the vertical transforms selected respectively for the w×h sub-partition, where w is the width and h is the height. Then the transform is selected according to the following rules:
   If w=1 or h=1, then there is no horizontal or vertical transform respectively.
   If w≥4 and w≤16, t_{H}=DST-VII, otherwise, t_{H}=DCT-II
   If h≥4 and h≤16, tᵥ=DST-VII, otherwise, tᵥ=DCT-II

In ISP mode, all 67 intra modes are allowed. PDPC is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

### Geometric Partitioning Mode (GPM)

In VVC, a Geometric Partitioning Mode (GPM) is supported for inter prediction as described in JVET-W2002 (Adrian Browne, et al., Algorithm description for Versatile Video Coding and Test Model 14 (VTM 14), ITU-T/ISO/IEC Joint Video Exploration Team (JVET), 23rd Meeting, by teleconference, 7-16 Jul. 2021, document: document JVET-M2002). The geometric partitioning mode is signalled using a CU-level flag as one kind of merge mode, with other merge modes including the regular merge mode, the MMVD mode, the CIIP mode and the subblock merge mode. A total of 64 partitions are supported by geometric partitioning mode for each possible CU size, w×h=2m×2″ with m, n E {3 . . . 6} excluding 8×64 and 64×8. The GPM mode can be applied to skip or merge CUs having a size within the above limit and having at least two regular merge modes.

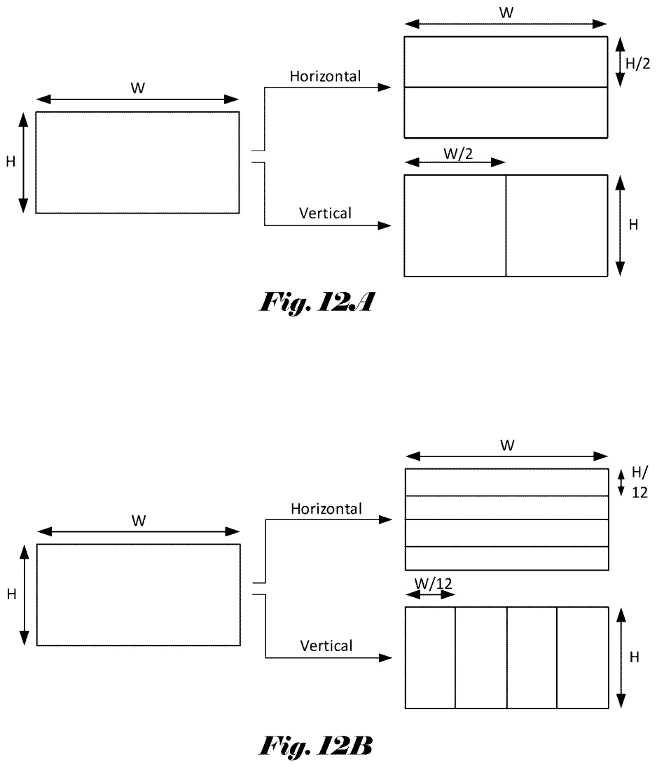

When this mode is used, a CU is split into two parts by a geometrically located straight line in certain angles. In VVC, there are a total of 20 angles and 4 offset distances used for GPM, which has been reduced from 24 angles in an earlier draft. The location of the splitting line is mathematically derived from the angle and offset parameters of a specific partition. In VVC, there are a total of 64 partitions as shown in FIG. 13, where the partitions are grouped according to their angles and dashed lines indicate redundant partitions. Each part of a geometric partition in the CU is inter-predicted using its own motion; only uni-prediction is allowed for each partition, that is, each part has one motion vector and one reference index. In FIG. 13, each line corresponds to the boundary of one partition. The partitions are grouped according to its angle. For example, partition group 1310 consists of three vertical GPM partitions (i.e. 90°). Partition group 1320 consists of four slant GPM partitions with a small angle from the vertical direction. Also, partition group 1330 consists of three vertical GPM partitions (i.e. 270°) similar to those of group 1310, but with an opposite direction. The uni-prediction motion constraint is applied to ensure that only two motion compensated prediction are needed for each CU, same as the conventional bi-prediction. The uni-prediction motion for each partition is derived using the process described later.

If geometric partitioning mode is used for the current CU, then a geometric partition index indicating the selected partition mode of the geometric partition (angle and offset), and two merge indices (one for each partition) are further signalled. The number of maximum GPM candidate size is signalled explicitly in SPS (Sequence Parameter Set) and specifies syntax binarization for GPM merge indices. After predicting each of part of the geometric partition, the sample values along the geometric partition edge are adjusted using a blending processing with adaptive weights using the process described later. This is the prediction signal for the whole CU, and transform and quantization process will be applied to the whole CU as in other prediction modes. Finally, the motion field of a CU predicted using the geometric partition modes is stored using the process described later.

### Uni-Prediction Candidate List Construction

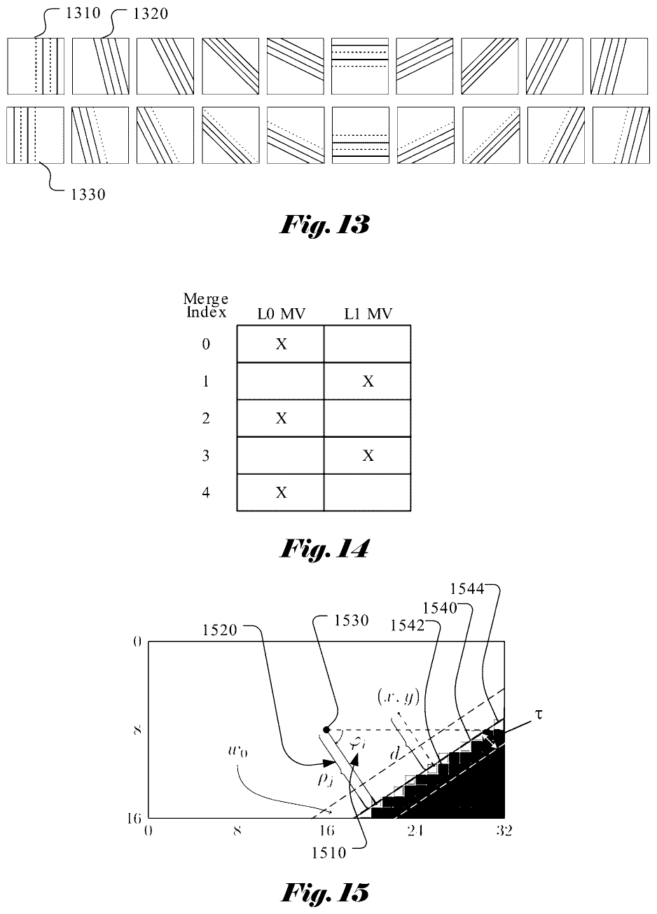

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate (X=0 or 1, i.e., LX=L0 or L1), with X equal to the parity of n, is used as the n-th uni-prediction motion vector for geometric partitioning mode. These motion vectors are marked with “x” in FIG. 14. In case a corresponding LX motion vector of the n-the extended merge candidate does not exist, the L(1-X) motion vector of the same candidate is used instead as the uni-prediction motion vector for geometric partitioning mode.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 3 )$$

$${ρ}_{j} = {ρ}_{x , j} cos ( {φ}_{i} ) + {ρ}_{y , j} sin ( {φ}_{i} ) \qquad ( 4 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 5 )$$

$${ρ}_{y , j} = \{ \begin{matrix}\pm ( j \times w ) ≫ 2 & i \% 16 = 8 or ( i \% 16 \neq 0 and h \geq w ) \\ 0 & otherwise\end{matrix} \qquad ( 6 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 7 )$$

$${w}_{0} ( x , y ) = \frac{Clip 3 ( 0 , 8 , ( wIdxL ( x , y ) + 4 ) ≫ 3 )}{8} \qquad ( 8 )$$

$${w}_{1} ( x , y ) = 1 - {w}_{0} ( x , y ) \qquad ( 9 )$$

The partIdx depends on the angle index i. One example of weigh w₀ is illustrated in FIG. 15, where the angle φ. 1510 and offset φ1520 are indicated for GPM index i and point 1530 corresponds to the centre of the block. Line 1540 corresponds to the GPM partitioning boundary

### Motion Field Storage for Geometric Partitioning Mode

Mv1 from the first part of the geometric partition, Mv2 from the second part of the geometric partition and a combined MV of Mv1 and Mv2 are stored in the motion filed of a geometric partitioning mode coded CU.

The stored motion vector type for each individual position in the motion filed are determined as:

sType=abs(motionIdx)<32?2:(motionIdx≤0?(1−partldx): partIdx) (10)
where motionIdx is equal to d (4x+2, 4y+2), which is recalculated from equation (7). The partIdx depends on the angle index i.

If sType is equal to 0 or 1, Mv0 or Mv1 are stored in the corresponding motion field, otherwise if sType is equal to 2, a combined MV from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.
   Bi-Prediction with CU-level Weight (BCW)

In HEVC, the bi-prediction signal, Pbi-pred is generated by averaging two prediction signals, P₀ and P₁ obtained from two different reference pictures and/or using two different motion vectors. In VVC, the bi-prediction mode is extended beyond simple averaging to allow weighted averaging of the two prediction signals.

P_{bi-pred}=((8−w)*P₀+w*P₁+4)>>3 (11)

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used. At the encoder, fast search algorithms are applied to find the weight index without significantly increasing the encoder complexity. These algorithms are summarized as follows. The details are disclosed in the VTM software and document JVET-L0646 (Yu-Chi Su, et. al., “CE4-related: Generalized bi-prediction improvements combined from JVET-L0197 and JVET-L0296”, Joint Video Experts Team (JVET) of ITU-T SG 16 WP 3 and ISO/IEC JTC 1/SC 29, 12th Meeting: Macao, CN, 3-12 Oct. 2018, Document: JVET-L0646).
When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP is also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and weight w is inferred to be 4 (i.e. equal weight is applied). For a merge CU, the weight index is inferred from neighbouring blocks based on the merge candidate index. This can be applied to both the normal merge mode and inherited affine merge mode. For the constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, (i.e., w=4 for equal weight). Equal weight implies the default value for the BCW index.

### Combined Inter and Intra Prediction (CIIP)

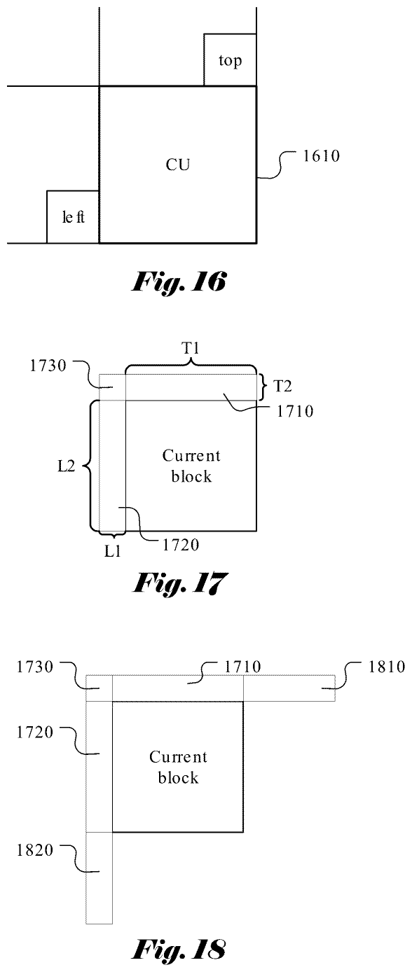

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pinter is derived using the same inter prediction process applied to regular merge mode; and the intra prediction signal Pintra is derived following the regular intra prediction process with the planar mode. Then, the intra and inter prediction signals are combined using weighted averaging, where the weight value wt is calculated depending on the coding modes of the top and left neighbouring blocks (as shown in FIG. 16) of current CU 1610 as follows:
If the top neighbour is available and intra coded, then set isIntraTop to 1, otherwise set isIntraTop to 0;
If the left neighbour is available and intra coded, then set isIntraLeft to 1, otherwise set isIntraLeft to 0;
If (isIntraLeft+isIntra Top) is equal to 2, then wt is set to 3;
Otherwise, if (isIntraLeft+isIntraTop) is equal to 1, then wt is set to 2;
Otherwise, set wt to 1.

The CIIP prediction is formed as follows:

P_{CIIP}=((4−wt)*Pᵢₙₜₑᵣ+wt*Pᵢₙₜᵣₐ+2)>>2 (12)

In this invention, a novel mechanism of deriving one or more prediction modes for the current block (for example, one or more intra prediction modes for the current block) is disclosed. When deriving the one or more intra prediction modes, neighbouring L-shape reference samples (e.g. neighbouring reconstructed and/or predicted samples) and any extension or subset of the neighbouring L-shape reference samples are used. FIG. 17 shows an example of neighbouring L-shape reference samples. The neighbouring L-shape reference samples include top region 1710, left region 1720, and/or top-left region 1730 as shown in FIG. 17. The size (top region width x top region height, denoted as T1×T2) of top region can be set as T1 equal to the block width and T2 equal to a pre-defined positive value as shown in FIG. 17. A similar way is applied to the left region. The size (left region width x left region height, denoted as L1×L2) of left region can be set as L1 equal to a pre-define positive value and L2 equal to the block height as shown in FIG. 17. There are more variations of using neighbouring L-shape reference samples.

In one embodiment, the extension of the neighbouring L-shape samples is used as extending the top region width and/or extending the left region height. For example, the top region width is extended to k*the block width, where k is larger than 1. Similarly, the left region height is extended to k*the block height, where k is larger than 1.

In another embodiment, the extension of the neighbouring L-shape samples is used as extending the top region width and/or extending the left region height as shown in FIG. 18. The top region width is extended to the block width 1710+a predefined k′ 1810. Similarly, the left region height is extended to the block height 1720+a predefined k″ 1820. k′ and k″ can be set as any positive integer. For example, k′ is the block height and/or k″ is the block width.

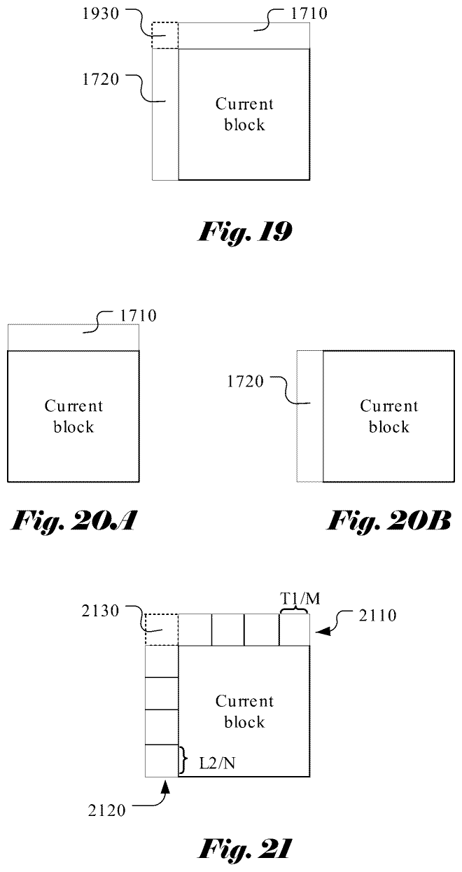

In another embodiment, the subset of the neighbouring L-shape reference samples is used by excluding the top-left region of the neighbouring L-shape reference samples as shown in FIG. 19, where the upper-left region 1930 is removed as shown by a dotted-line box.

In another embodiment, the subset of the neighbouring L-shape reference samples is used by only including the top region of the neighbouring L-shape reference samples as shown in FIG. 20A.

In another embodiment, the subset of the neighbouring L-shape reference samples is used by only including the left region of the neighbouring L-shape reference samples as shown in FIG. 20B.

When deriving the one or more intra prediction modes, the used neighbouring reference samples are divided into one or more sub-regions and a pre-defined derivation method is performed on a sub-region to get a representative intra prediction mode (also named as a target representative intra prediction mode) from the sub-region. Take the following as an example to illustrate the proposed sub-region based intra mode derivation. However, the proposed method is not limited to this specific example. Instead, the proposed method can also be applied to any proposed version of neighbouring reference samples. As shown in FIG. 21, the top reference region is divided into sub-regions 2110 and the left reference region is also divided into sub-regions 2120.

In one embodiment, for the top reference region, a dividing factor M is pre-defined to divide the top reference region into the sub-regions with the sub-region width equal to T1/M as shown in FIG. 21. Similarly, another dividing factor N is pre-defined to divide the left region into the sub-regions with the sub-region height equal to L2/N as shown in FIG. 21. For example, a same value is set to M and N, where M=N=2, 4, 8, or any positive integer (which may be defined in the standard or determined by the signalling at block, slice, tile, picture, SPS, PPS, and/or picture level). For another example, M and N can be different. For another example, M and/or N can vary with the block width, block height, and/or block area of the current block. In one case, if the block width is larger than a threshold, M is set as a number larger than 1. In another case, if the block height is larger than a threshold, N is set as a number larger than 1. In another case, if the block width is smaller than a threshold, Mis set as 1. In another case, if the block height is smaller than a threshold, N is set as 1. If the width of the current block is larger than the height of the current block, M is larger than N; otherwise, M is smaller than or equal to N. For another example, the dividing factors here will follow the dividing for the current block described in the sections below.

In another embodiment, when M is set equal to 1, that means no dividing process is applied to the top region and only one representative intra prediction mode is decided according to the pre-defined derivation method. Similarly, when N is set equal to 1, no dividing process is applied to the left region and only one representative intra prediction mode is decided according to the pre-defined derivation method.

In another embodiment, the pre-defined derivation method is as follows. One or more candidate lists are defined. For example, the candidate list includes the MPM list (primary and/or secondary MPMs or any subset or extension of the above) for the current block. For another example, the candidate list includes any subset of all available intra prediction modes (e.g. 67 intra prediction modes). For a pre-defined region in the top region, a pre-defined process is performed on the pre-defined region (e.g. generating predictors for each candidate mode (in the candidate list for the pre-defined region) on the pre-defined region as what TIMD does, or applying gradient calculation on the pre-defined region as what DIMD does) to get the representative intra prediction mode from the pre-defined region. Take TIMD as an example. The representative intra prediction mode will be the mode which has the smallest cost among candidates in the candidate list, where the cost can be calculated by any pre-defined measurement metrics (e.g. SAD and/or SATD). When the pre-defined region is the whole top region, one representative intra prediction mode is obtained. When the pre-defined region is a sub-region in the following example (including 4 sub-regions in the top region), one representative intra prediction mode is from each sub-region. Similar way is used for the left region.

In one sub-embodiment, the candidate list for each sub-region can be the same or different.
For example, the derived modes of the representative intra prediction mode (with the mode index ranging in (the mode index of the representative intra prediction mode+/−a predefined positive integer offset)) from the previous sub-region can be added into the candidate list for the current sub-region.
For another example, an initial intra prediction mode (with mode index equal to G) is generated according to the whole reference region, such as whole L region or whole top and left region by calculating costs (e.g. TIMD costs) for each mode in the pre-defined intra prediction mode set, such as the 67 intra prediction modes or MPMs, on the whole reference region. Then, the candidate list for each sub-region can be derived according to the initial intra prediction mode. One possible way is that the candidate list for each sub-region includes the modes with mode index ranging in {G-offset1, Groffset2}, where offset1 and offsest2 can be the same for each sub-region. Another possible way is that the candidate list for each sub-region includes the modes with mode index ranging in {G-offset1, G+offset2}, where offset1 and offsest2 can be different for each sub-region.
   Offset1 and offsest2 can vary with the block width, height, or area.
   Offset1 and offsest2 can vary with the sub-region width, height, or area.
   Offset1 and offsest2 can vary with the calculated costs of the candidate mode. For the current sub-region, if the calculated costs are all larger than a pre-defined number (e.g. sub-region size), more candidate modes are needed and offset1 and/or offset2 are increased. If any calculated cost is smaller than a pre-defined number (e.g. sub-region size), less candidate modes are needed and offset1 and/or offset2 are reduced.

In another sub-embodiment, two candidate lists are designed for the top region and left region, respectively. Each sub-region in the top region uses one candidate list and each sub-region in the left region uses the other candidate list. For example, the derived modes of the representative intra prediction modes from left (or top) region are added into the candidate list for top(or left) region.

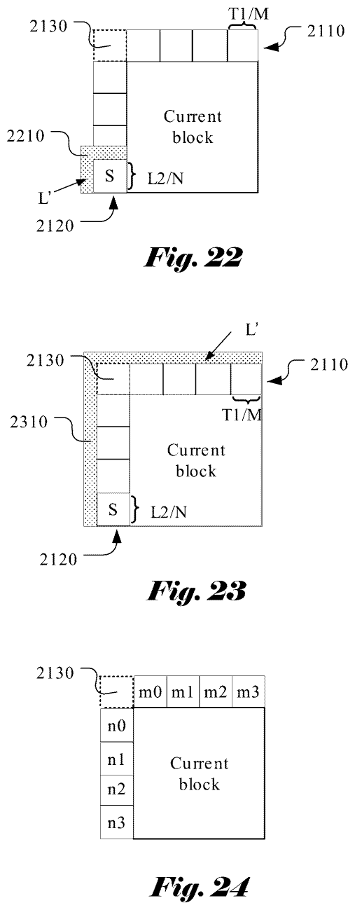

In another sub-embodiment, when generating predictors on the pre-defined region, the reference samples to generate the predictors are the adjacent L shape of the pre-defined region. If the pre-defined region is the sub-region (denoted as S in the FIG. 22), the adjacent L shape is labelled as L′ 2210. Then for each pre-defined region, the cost of a certain candidate intra prediction mode is calculated by measuring the difference between the reconstructed samples and predicted samples at the pre-defined region.

In another sub-embodiment, when generating predictors on the pre-defined region, the reference samples to generate the predictors are the outer L shape of the top and left regions. If the pre-defined region is the sub-region (denoted as S in FIG. 23), the outer L shape is labelled as L′ 2310 in FIG. 23. In implementation, the predictors for the top region and left region are generated by using the out L. Then for each pre-defined region, the cost of a certain candidate intra prediction mode is calculated by measuring the difference between the reconstructed samples and predicted samples at the pre-defined region. In another sub-embodiment, the reference samples to generate the predictors at the pre-defined region for the proposed methods are unified with the reference samples to generate the predictors at the above and left regions for original TIMD. Therefore, for each candidate prediction mode, the predictors at the top and left regions are generated only one time. When doing original TIMD, the cost for a candidate prediction mode is based on the distortion between the generated predictors and the reconstructed samples at both of the above and left template regions. When doing proposed methods, the cost for a candidate prediction mode is based on the distortion between the generated predictors and the reconstructed samples at a pre-defined region (within either above or left template region).

When generating the predictors of the current block, a weighting scheme (including weight for each hypothesis) is designed to blend one or more hypotheses of predictions from one or more representative intra prediction modes. Finally, a right-shifting process and/or a rounding factor are needed. If the summation of the weights is 64, adding a rounding factor equal to 32 and then right-shifting 6 bits are required after blending.

In one embodiment, first of all, generate a hypothesis of prediction for the current block (or one or more subblocks in the current block) according to each representative intra prediction mode. FIG. 24 shows an example of this embodiment, where a total of 8 representative intra prediction modes (denoted as m0, m1, m2, m3, n0, n1, n2, and n3) are derived from the neighbouring suggestion and 8 hypotheses of predictions for the current block are generated. Then, those hypotheses of predictions are blended for the current block according to a predefined weighting scheme.

In one sub-embodiment, the weighting is sample-based. That is, each sample will derive its own weight. The weighting includes the weight for each hypothesis of prediction. For example, p(x, y)=w0(x,y)*p0(x,y)+w1(x,y)*p1(x,y)+w2(x,y)*p2(x, y)+ . . . +w7(x,y)*p7(x,y), where (x, y) is the sample position in the current block, p(x, y) is the blended predictor at (x, y), pᵢ(x, y) is the to-be-blended predictor for (x, y) from the hypothesis i and wᵢ(x, y) is the weight for pᵢ(x, y). The weight depends on the sample position within the current block, the block width or height of the current block, the cost of the representative intra prediction mode, and/or the distance between the sample position and the corresponding region that recommends the representative intra prediction for generating hypothesis i of prediction.

In another embodiment, first of all, generate a hypothesis of prediction for the current block (or one or more subblocks in the current block) according to each representative intra prediction mode. FIG. 25 shows an example for this embodiment, where a total of 2 representative intra prediction modes (denoted as m0 and n0) are derived from the neighbouring suggestion and 2 hypotheses of predictions for the current block are generated. Then, those hypotheses of prediction are blended for the current block according to a predefined weighting scheme.

In one sub-embodiment, the weighting is sample-based. That is, each sample will derive their own weight. The weighting includes the weight for each hypothesis of prediction. For example, p(x, y)=w0(x,y)*p0(x,y)+w1(x,y)*p1(x, y), where (x, y) is the sample position in the current block, p(x, y) is the blended predictor at (x, y), pᵢ(x, y) is the to-be-blended predictor for (x, y) from the hypothesis i and wᵢ(x, y) is the weight for pᵢ(x, y). The weight depends on the sample position within the current block, the block width or height of the current block, the cost of the representative intra prediction mode, and/or the distance between the sample position and the corresponding region that recommends the representative intra prediction for generating hypothesis i of prediction. For example, p0 is generated by m0 and p1 is generated by n0. w0(x, y) can be

$$I + \frac{I * x}{W} - \frac{I * y}{H} ,$$

where i depends on the pre-defined summation of weights. w1 is (the summation of weights)−w0. If the summation of weighting is 64, I=half of 64=32. In some cases, the weight will further depend on the costs of the representative intra prediction modes. The cost of m0 is first normalized/scaled according to the top region area/size and the cost of no is first normalized/scaled according to the left region area/size. Then, if the cost for m0 is much larger than the cost from no, w0 is reduced. For example, w0 is reduced as

$$I + \frac{I * x}{W} - \frac{2 * I * y}{H} .$$

If the cost for n0 is much larger than the cost from m0, w0 is increased. For example, w0 is reduced as

$$I + \frac{2 I * x}{W} - \frac{I * y}{H} .$$

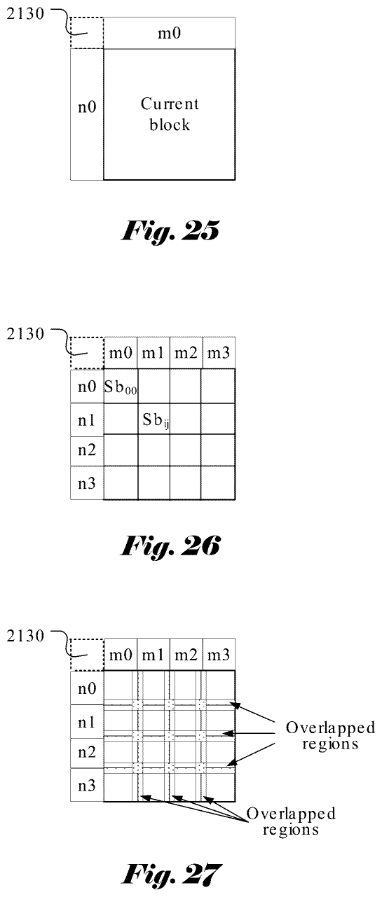

In another embodiment, the current block is divided into multiple sub-blocks. Each subblock will get one or more representative intra prediction modes from its corresponding one or more reference sub-regions. FIG. 26 shows an example of a 16×16 block. The 16×16 block is divided into 16 subblocks (denoted as sbᵢⱼ where i=0, 1, 2, or 3 and j=0, 1, 2, or 3). For sb₀₀, its corresponding reference sub-regions include one sub-region from the top region and the other sub-region from the left region, Therefore, sb₀₀ will get one representative intra prediction mode (denoted as m0) from the top region and the other representative intra prediction mode (denoted as n0) from the left region. Similarly, sb₀₁ will get m0 and n1, sbio will get m1 and n0, etc.

In one sub-embodiment, the weighting is sample-based. That is, each sample will derive their own weight. The weighting includes the weight for each hypothesis of prediction. Take sb₀₀ as an example. p(x, y)=w0(x,y)*p0(x,y)+w1(x,y)*p1(x, y), where (x, y) is the sample position in the current block, p(x, y) is the blended predictor at (x, y), pᵢ(x, y) is the to-be-blended predictor for (x, y) from the hypothesis i and wᵢ(x, y) is the weight for pᵢ(x, y). The weight depends on the sample position within the current block, the block width or height of the current block, the cost of the representative intra prediction mode, and/or the distance between the sample position and the corresponding region that recommends the representative intra prediction for generating hypothesis i of prediction. For example, p0 is generated by m0 and p1 is generated by n0. w0(x, y) can be

$$I + \frac{I * x}{W} - \frac{I * y}{H} ,$$

where i depends on the pre-defined summation of weights. w1 is (the summation of weights)−w0. If the summation of weighting is 64, I=half of 64=32. In some cases, the weight will further depend on the costs of the representative intra prediction modes. The cost of m0 is first normalized/scaled according to the top sub-region area/size and the cost of no is first normalized/scaled according to the left sub-region area/size. Then, if the cost for m0 is much larger than the cost from n0, w0 is reduced. For example, w0 is reduced as

$$I + \frac{I * x}{W} - \frac{2 * I * y}{H} .$$

If the cost for no is much larger than the cost from m0, w0 is increased. For example, w0 is reduced as

$$I + \frac{2 I * x}{W} - \frac{I * y}{H} .$$

In another sub-embodiment, when dividing the current block into subblocks, the prediction in the overlapping region will use further blended predictions generated according to the intra prediction modes of neighbouring blocks. For example, for sb₀₁, in additional to the original predicted samples in sb₀₁ (from m0 and n1), the overlapping region in the upper portion within sb₀₁ will further blend with the prediction generated according to n0. FIG. 27 shows the overlapped regions (as indicated by dotted areas) for all subblocks. The blending weight (e.g. 1) for the prediction from no will be smaller than the blending weight (e.g. 3) for the original predicted samples.

In another sub-embodiment, a general representative intra prediction mode is decided according to both the top and left whole regions. A hypothesis of prediction generated from the general representative intra prediction mode is further blended with the predicted samples in the current block.

In another sub-embodiment, when dividing the current block into multiple subblocks, the size of each subblock is pre-defined. For example, the size of a subblock is 4×4.

In another sub-embodiment, when dividing the current block into multiple subblocks, the total number of subblocks is pre-defined. For example, the total number of subblocks is 4×4, so the size of each subblock is (the block width/4)×(the block height/4).

In another embodiment, the proposed novel mechanism is enabled and/or disabled according to implicit rules (e.g. block width, height, or area) or according to explicit rules (e.g. syntax on block, tile, slice, picture, SPS, or PPS level). For example, an additional flag is signalled to indicate whether to apply the proposed novel mechanism to the current block. For another example, the proposed novel mechanism is treated as an optional mode of TIMD and/or DIMD. Therefore, when TIMD flag indicates to use TIMD for the current block, the proposed flag is then signalled (especially for the case that the proposed method is treated as an optional mode of TIMD). When the proposed method is treated as an optional mode of DIMD and DIMD flag indicates to use DIMD for the current block, the proposed flag is then signalled. In another embodiment, the proposed flag is inferred as disabled when any of the enabling conditions of the proposed methods is not satisfied. The enabling conditions include the checking of the implicit rules and/or the explicit rules. For example, the checking of the implicit rules is related to the block width, height, and/or block area of the current block. In one case, if the block width and/or block height are larger than a pre-defined threshold, the checking is satisfied. In another case, if the block width is smaller (or larger) than the block height multiplied by a positive integer and/or the block height is smaller (or larger) than the block width multiplied by a positive integer, the checking is satisfied. For another example, the checking of explicit rules is related to the supported mode. If the supported mode refers to TIMD, the checking is satisfied if the current block is coded by TIMD.

In another embodiment, any proposed methods or any combinations of the proposed methods can be applied to other intra modes (i.e., not restricted to TIMD/DIMD) such as normal intra mode, WAIP (Wide Angular Intra Prediction), intra angular modes, ISP, MIP (Matrix-weighted Intra Prediction), intra block copy (IBC) which uses block vector information (derived according to the signalled syntax and/or the inheritance or derivation from the neighbouring template region of the current block) to reference the reconstructed block in the current picture to predict the current block, intra template matching prediction (intra TMP) which uses block vector information (derived based on the matching results of searching in a pre-defined neighbouring template region of the current block), or any intra mode specified in the VVC or HEVC. For example, the proposed methods can be used for any modes which apply pre-defined measurement on the neighbouring template region (including left and above template regions) of the current block to derive the one or more prediction modes for the current block. Using the proposed methods refer to get separate suggested prediction modes from left and above template regions, respectively. The prediction of the current block can be formed according to the suggested prediction modes (only) from the above template region and/or the suggested prediction modes (only) from the left template region.

The proposed methods in this invention can be enabled and/or disabled according to implicit rules (e.g. block width, height, or area) or according to explicit rules (e.g. syntax on block, tile, slice, picture, SPS, or PPS level). For example, the proposed method is applied when the block area is smaller/larger than a threshold.

The term “block” in this invention can refer to TU/TB, CU/CB, PU/PB, pre-defined region, or CTU/CTB.

Any combination of the proposed methods in this invention can be applied.

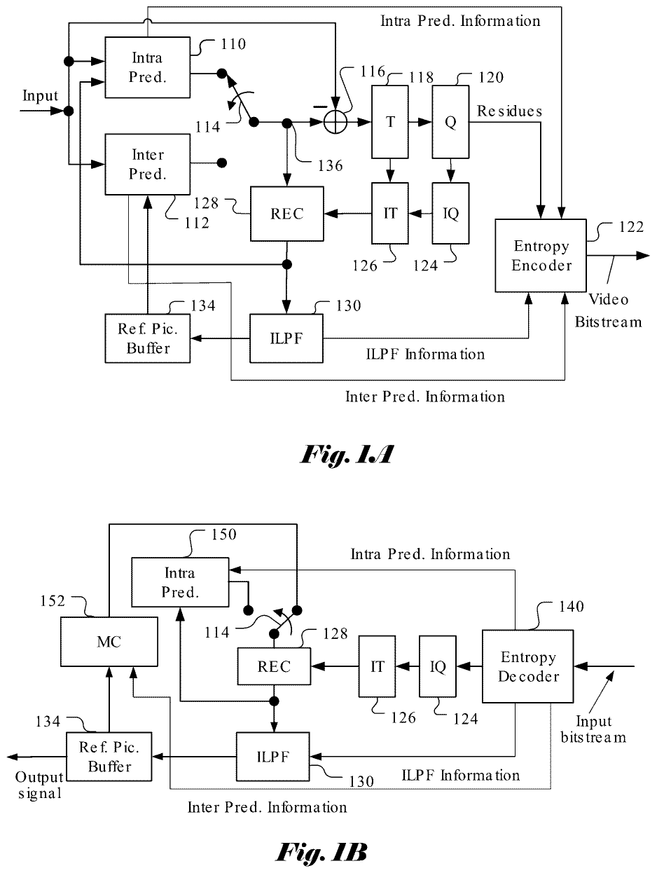

The region-based intra prediction mode derivation as described above can be implemented in an encoder side or a decoder side. For example, any of the proposed methods can be implemented in an Intra prediction module (e.g. Intra Pred. 150 in FIG. 1B) in a decoder or an Intra prediction module in an encoder (e.g. Intra Pred. 110 in FIG. 1A in FIG. 1B). Any of the proposed methods can also be implemented as a circuit coupled to the intra coding module at the decoder or the encoder. However, the decoder or encoder may also use additional processing unit to implement the required processing. While the Intra prediction units (e.g. unit 110 in FIG. 1A and unit 150 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

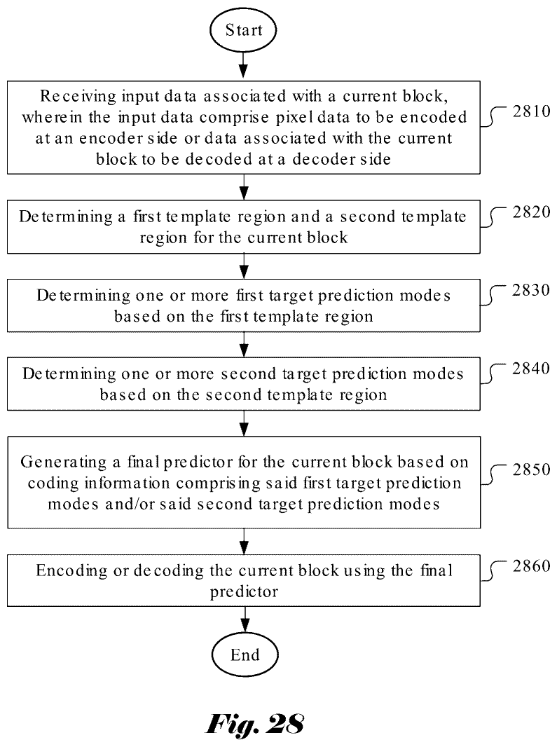

FIG. 28 illustrates a flowchart of an exemplary video coding system that incorporates blending multiple representative intra modes derived from multiple template region according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block are received in step 2810, wherein the input data comprise pixel data to be encoded at an encoder side or data associated with the current block to be decoded at a decoder side. A first template region and a second template region are determined for the current block in step 2820. One or more first target prediction modes are determined based on the first template region in step 2830. One or more second target prediction modes are determined based on the second template region in step 2840. A final predictor for is generated the current block based on coding information comprising said first target prediction modes and said second target prediction modes in step 2850. The current block is encoded or decoded using the final predictor in step 2860.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprises pixel data to be encoded at an encoder side or data associated with the current block to be decoded at a decoder side;
determining a first template region and a second template region for the current block;
determining one or more first target prediction modes based on the first template region;
determining one or more second target prediction modes based on the second template region;
generating a final predictor for the current block based on coding information comprising said first target prediction modes and/or said second target prediction modes; and
encoding or decoding the current block using the final predictor.

2. The method of claim 1, wherein the first template region corresponds to a top template on a top side of the current block and the second template region corresponds to a left template on a left side of the current block.

3. The method of claim 1, wherein a first prediction candidate list is determined for the first template region.

4. The method of claim 3, wherein first costs associated with first prediction candidates in the first prediction candidate list are calculated, and said one or more first target prediction modes are selected according to the first costs.

5. The method of claim 4, wherein the first costs associated with the first prediction candidates in the first prediction candidate list are calculated based on histogram/gradient analysis on the first template region, distortion calculation on the first template region, and/or any-pre-defined measurement on the first template region.

6. The method of claim 3, wherein a second prediction candidate list is determined for the second template region.

7. (canceled)

8. The method of claim 6, wherein second costs associated with second prediction candidates in the second prediction candidate list are calculated, and said one or more second target prediction modes are selected according to the second costs.

9. The method of claim 8, wherein the second costs associated with the second prediction candidates in the second prediction candidate list are calculated based on histogram/gradient analysis on the second template region, distortion calculation on the second template region, and/or any-pre-defined measurement on the second template region.

10. (canceled)

11. (canceled)

12. (canceled)

13. (canceled)

14. (canceled)

15. The method of claim 1, wherein the first template region is divided into one or more first template sub-regions and/or the second template region is divided into one or more second template sub-regions, and wherein one or more first target sub-region prediction modes are derived for each of said one or more first template sub-regions and/or one or more second target sub-region prediction modes are derived for each of said one or more second template sub-regions.

16. The method of claim 15, wherein said each of said one or more first template sub-regions is derived based on first sub-region costs associated with said each said one or more first template sub-regions and/or said each of said one or more second template sub-regions is derived based on second sub-region costs associated with said each said one or more second template sub-regions.

17. The method of claim 16, wherein the final predictor for the current block is generated based on the coding information comprising said one or more first target sub-region prediction modes and said one or more second target sub-region prediction modes.

18. The method of claim 16, wherein in response to only the first template region being divided into one or more first template sub-regions, the final predictor for the current block is generated based on the coding information comprising said one or more first target sub-region prediction modes and said one or more second target prediction modes.

19. The method of claim 16, wherein in response to only the second template region being divided into one or more second template sub-regions, the final predictor for the current block is generated based on the coding information comprising said one or more first target prediction modes and said one or more second target sub-region prediction modes.

20. The method of claim 16, wherein the current block is divided into subblocks, and final subblock predictors for the subblocks are generated based on the coding information comprising said one or more first target sub-region prediction modes and/or said one or more second target sub-region prediction modes respectively.

21. The method of claim 16, wherein the current block is divided into subblocks according to block width, block height, block area, dividing on the first template region, dividing on the second template region, or a combination thereof.

22. The method of claim 16, wherein each of the first sub-region costs or each of the second sub-region costs is calculated for each first sub-region or each second sub-region respectively using reference samples corresponding to all or any subset of outer reference L shape around the first template region on a top side of the current block and around the second template region on a left side of the current block.

23. The method of claim 16, wherein each of the first sub-region costs or each of the second sub-region costs is calculated for each first sub-region or each second sub-region respectively using the reference samples adjacent to said each first sub-region or said each second sub-region respectively.

24. The method of claim 16, wherein an overlapping area is determined around a boundary between two adjacent subblocks of the current block, and the overlapping area is further blended according to two prediction modes associated with the two adjacent subblocks of the current block.

25. An apparatus of video coding, the apparatus comprising one or more electronics or processors arranged to:
receive input data associated with a current block, wherein the input data comprises pixel data to be encoded at an encoder side or data associated with the current block to be decoded at a decoder side;
determine a first template region and a second template region for the current block;
determining one or more first target prediction modes based on the first template region;
determine one or more second target prediction modes based on the second template region;
generate a final predictor for the current block based on coding information comprising said first target prediction modes and/or said second target prediction modes; and
encode or decode the current block using the final predictor.
